(19) United States
(12) Patent Application Publication
(10) Pub. No.: US 2013/0257033 A1
(43) Pub. Date: Oct. 3, 2013

(54) AUTOMOTIVE BUYER GUIDE AND METHODS OF MAKING SAME

(71) Applicant: WARD KRAFT, INC., Fort Scott, KS (US)

(72) Inventors: Phillip R. Quick, Fort Scott, KS (US); Jesse D. Crum, Fort Scott, KS (US)

(73) Assignee: WARD KRAFT, INC., Fort Scott, KS (US)

(21) Appl. No.: 13/786,307

(22) Filed: Mar. 5, 2013

Related U.S. Application Data
(60) Provisional application No. 61/606,765, filed on Mar. 5, 2012.

(51) Int. Cl. B42D 15/00

(52) U.S. Cl. CPC B42D 15/00
USPC 283/56

(57) ABSTRACT

An automotive buyer guide comprises a front side having a central portion and an outer portion. The central portion and the outer portion are separated by a perforated border. The guide includes a back side which has an adhesive area that generally corresponds to the outer portion. At least part of the adhesive area comprises adhesive. A liner generally corresponding to the adhesive area is removably affixed to it. The adhesive area is configured to allow for securement of the back side to a window of the vehicle. The central portion can be detached from the outer portion along the perforated border after the automotive buyer guide is secured to the window.

### CROSS-REFERENCE TO RELATED APPLICATIONS

This Application claims priority to U.S. Provisional Patent Application Ser. No.: 61/606,765 filed Mar. 5, 2012, the disclosure of which is incorporated herein by reference in its entirety.

### FIELD OF THE INVENTION

The invention relates generally to the field of documents that may be secured to windows of vehicles, such as trucks, cars, and the like. More specifically, the invention relates to the field of automotive buyer guides.

### BRIEF SUMMARY OF THE INVENTION

Automotive buyer guides and methods for making and using same are disclosed herein. According to one embodiment, an automotive buyer guide comprises a dealer page having a first front side and a first back side. The automotive buyer guide further comprises a buyer page having a second front side and a second back side. The second front side has a central portion and an adhesive portion surrounding the central portion. At least part of the adhesive portion comprises an adhesive. The central portion and the adhesive portion are separated by a perforated boundary. A liner generally corresponding to the adhesive portion is removably affixed to the adhesive portion. A carbon copy sheet is disposed between the dealer page and the buyer page. The carbon copy sheet is adjacent the first back side and the second front side. The guide further includes an instruction area, and the dealer page, the carbon copy sheet, and the buyer page are each removably secured to the instruction area at a first perforated border, a second perforated border, and a third perforated border, respectively. The adhesive portion is configured to allow for securement of the buyer page to an inside of a window of a vehicle after the buyer page is detached from the instruction area. The central portion can be detached from the adhesive portion along the perforated boundary after the buyer page is secured to the window.

According to another embodiment, a method for a seller to convey information about a vehicle for sale to a buyer comprises the step of providing an automotive buyer guide. The guide comprises a seller page having a first front side and a first back side. The guide further comprises a buyer page having a second front side and a second back side. The second front side has a central portion and an adhesive portion that surrounds the central portion. At least part of the adhesive portion comprises an adhesive. The central portion and the adhesive portion are separated by a perforated boundary. A liner generally corresponding to the adhesive portion is removably affixed to the adhesive portion. A carbon copy sheet is disposed between the seller page and the buyer page such that it is adjacent the first back side and the second front side. The carbon copy sheet is configured to duplicate indicia placed on the first front side onto the second front side. The guide further comprises an instruction area and the seller page is removably secured to the instruction area at a first perforated border. The carbon copy sheet is removably secured to the instruction area at a second perforated border, and the buyer page is removably secured to the instruction area at a third perforated border. The adhesive portion is configured to allow for securement of the buyer page to a window of a vehicle after the buyer page is detached from the instruction area. The central portion can be detached from the adhesive portion along the perforated boundary after the buyer page is secured to the window. The method further comprises the steps of placing indicia on the front side and detaching the buyer page from the instruction area. The liner is removed from the adhesive portion. The buyer page is secured to an inside of the window such that the adhesive portion is in contact with the window.

According to yet another embodiment, an automotive buyer guide comprises a front side having a central portion and an outer portion. The central portion and the outer portion are separated by a perforated border. The guide includes a back side which has an adhesive area that generally corresponds to the outer portion. At least part of the adhesive area comprises adhesive. A liner generally corresponding to the adhesive area is removably affixed to the adhesive area. The adhesive area is configured to allow for securement of the back side to a window of the vehicle. The central portion can be detached from the outer portion along the perforated border after the automotive buyer guide is secured to the window.

### BRIEF DESCRIPTION OF THE DRAWINGS

Illustrative embodiments of the present invention are described in detail below with reference to the attached drawing figures and wherein:

FIG. 1 shows a front side of an automotive buyer guide in accordance with one embodiment of the current invention;

FIG. 2 shows a back side of the automotive buyer guide of FIG. 1;

FIG. 3 shows a liner being removed from the back side of the automotive buyer guide of FIG. 1;

FIG. 4 shows the liner of the automotive buyer guide of FIG. 1 after it has been removed;

FIG. 5 shows the back side of the automotive buyer guide of FIG. 1 after the liner has been removed;

FIG. 6 shows an adhesive placed on the automotive buyer guide of FIG. 1 according to an alternate arrangement;

FIG. 7(a) shows a central portion of the automotive buyer guide of FIG. 1 being removed with the use of a pencil;

FIG. 7(b) shows an outer portion of the automotive buyer guide of FIG. 1 secured to a window of a vehicle after the central portion has been removed;

FIG. 7(c) shows an alternate embodiment of the automotive buyer guide of FIG. 1 wherein a tab secured to the central portion can be pulled to detach the central portion;

FIG. 8 shows an automotive buyer guide in accordance with another embodiment of the current invention;

FIG. 9 shows a back side of a dealer page of the automotive buyer guide of FIG. 8;

FIG. 10 shows a front side of a buyer page of the automotive buyer guide of FIG. 8;

FIG. 11 shows the buyer page of the embodiment of FIG. 8 after the dealer page and a carbon copy sheet have been removed;

FIG. 12 shows a liner being removed from a front side of the buyer page of the embodiment of FIG. 8;

FIG. 13 shows a back side of the buyer page of the embodiment of FIG. 8;

FIG. 14 shows an outer area of the buyer page of the automotive buyer guide of FIG. 8 after a central area has been removed; and

FIG. 15 shows an alternate embodiment of the automotive buyer guide of FIG. 8 wherein a tab secured to the central area can be pulled to detach the central area.

### DETAILED DESCRIPTION

Embodiments of the present invention provide automotive buyer guides and methods for making automotive buyer guides. In this document, references are made to directions such as front, back, left, right, and the like. These references are exemplary only and are used to describe the disclosed invention in a typical orientation or operation, but are not independently limiting.

The Federal Trade Commission (“FTC”) requires dealers to post a buyer guide on every used car that the dealer offers for sale. Instances of non-compliance with this requirement may be punishable by fines of up to $11,000.00, per violation. Unsurprisingly, there is a large demand for automotive buyer guides that can be securely and conveniently posted on used vehicles that are offered for sale by dealers. Private sellers may also post such automotive buyer guides on vehicles they offer for sale to convey information about these vehicles to prospective buyers. Such automotive buyer guides may also be posted on new vehicles, such as new trucks, cars, minivans, and the like.

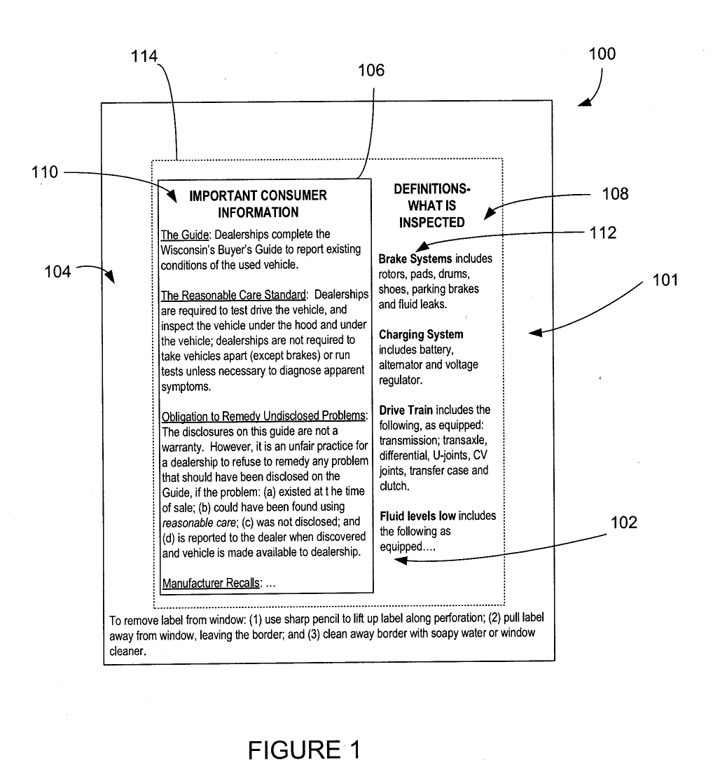

FIG. 1 shows a front side 101 of an automotive buyer guide 100 in accordance with one embodiment of the present invention. When viewed from the front 101, the guide 100 has a central portion 102 and an outer portion 104. The central portion 102 may include a text box 106, and a definitions column 108. The text box 106 may include information 110 that the FTC requires dealers to post on the used vehicles. The definitions column 108 may include definitions 112 of the various terms used in the text box 106. As will be appreciated by those skilled in the art, the information 110 in the text box 106 and the definitions 112 in the definitions column 108 may vary from one automotive buyer guide 100 to another automotive buyer guide 100, to reflect the varying requirements of different states and the particular preferences of dealers. As such, the information 110 in the text box 106 and the definitions 112 in the definitions column 108 in the figures are exemplary only. The text box 106 and the definitions column 108 are themselves also exemplary, and an automotive buyer guide 100 may include a plurality of text boxes 106 and/or definition columns 108, or no text boxes 106 and/or definition columns 108. The automotive buyer guide 100 may be rectangular (e.g., 8.5×11 inches) or square-shaped, or of other regular or irregular sizes and shapes. A perforated border 114 may separate the central portion 102 from the outer portion 104.

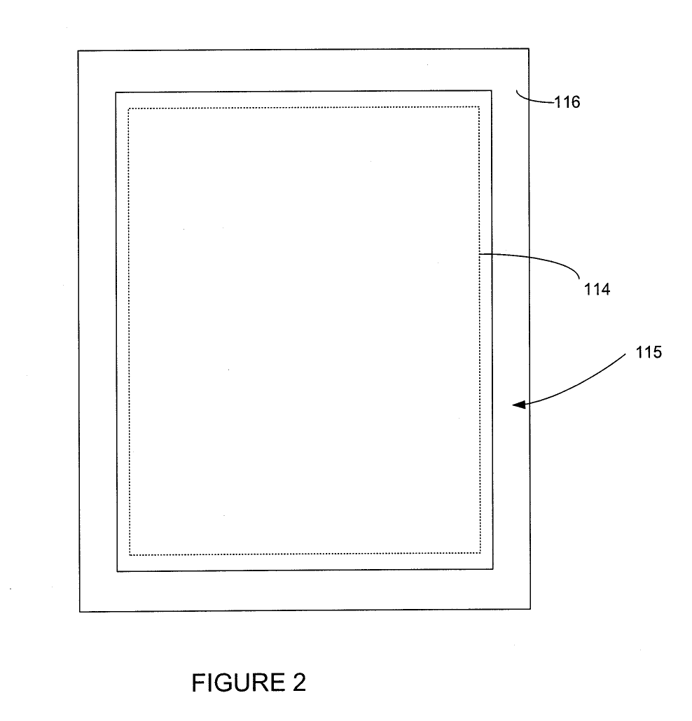

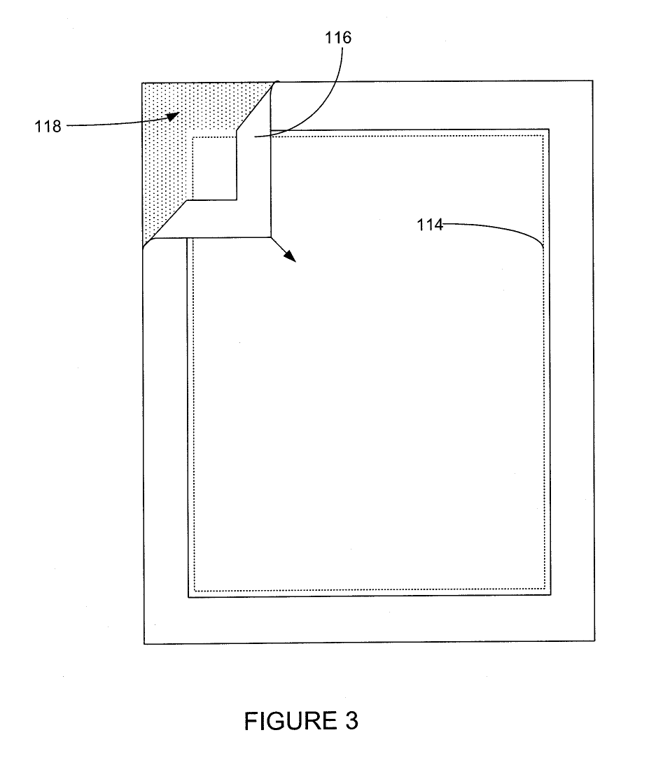

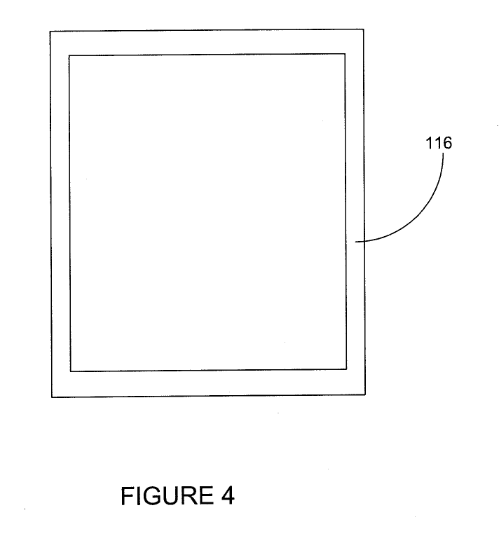

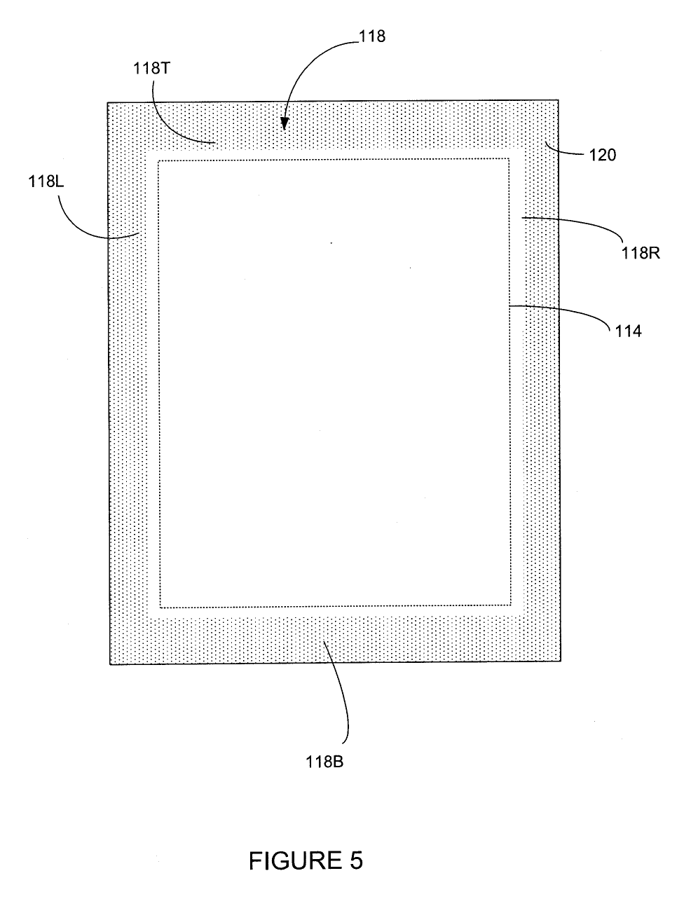

FIG. 2 shows the buyer guide 100 as viewed from a back side 115. While not specifically shown in the figures, the back side 115 may contain additional information about the vehicle (for e.g., its odometer reading, its engine size, et cetera). A liner 116 may surround the perforated border 114 on the back side 115. As can be seen in FIG. 3, the liner 116 may be pulled off the buyer guide 100 to expose an adhesive area 118. The liner 116 (FIG. 4) may then be disposed or recycled. FIG. 5 shows the back side 115 of the automotive buyer guide 100 after the liner 116 has been removed.

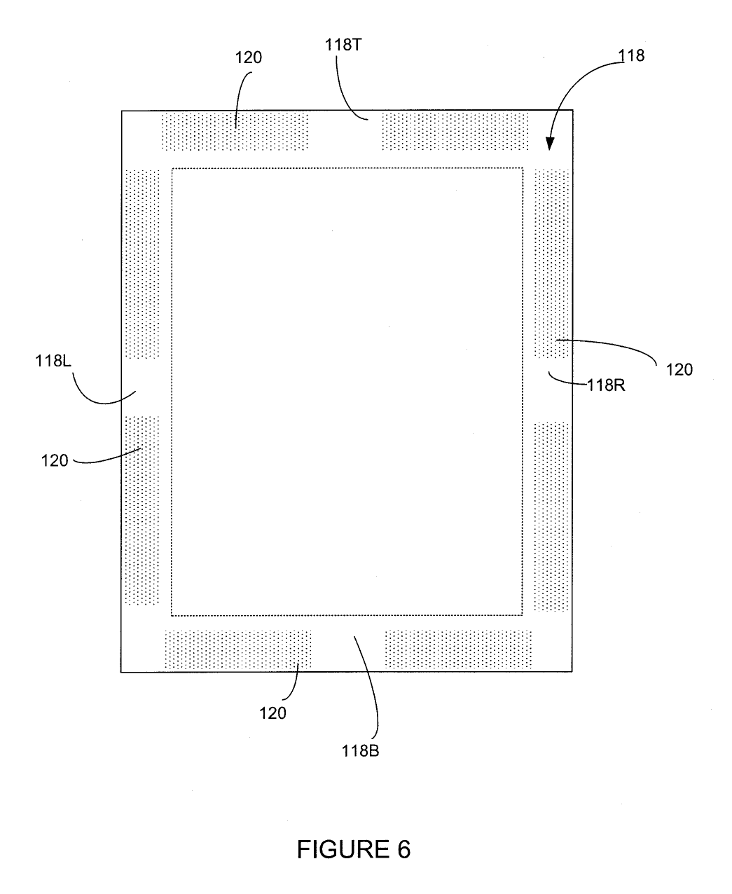

The adhesive area 118, which may surround the perforated border 114 on the back side 115, and which may generally correspond to the outer portion 104 on the front side 101, may have a top side 118T, a bottom side 118B, a left side 118L, and a right side 118R (FIG. 5). The adhesive area 118 may contain an adhesive 120, which may be a water soluble acrylic adhesive, or some other suitable adhesive that is preferably (but not necessarily) water soluble. The adhesive 120 may be applied to each of the top (118T), bottom (118B), left (118L), and right (118R) sides of the adhesive area 118 in a continuous pattern. For example, a flexographic printing plate 122, not shown in the figures, may be used to apply the adhesive 120 to the adhesive area 118 in a dot pattern, as it has been found that an adhesive 120 applied in this manner works well for the end use of the automotive buyer guide 100. Embodiments where only two sides (e.g., the top side 118T and the bottom side 118B) or three sides (e.g., the top side 118T, the bottom side 118B, and the left side 118L) of the adhesive area 118 contain the adhesive 120 are also contemplated. Further, it is possible to impart the adhesive 120 to only part of one or all the sides 118T, 118B, 118L, 118R of the adhesive area 118; for example, FIG. 6 shows the automotive buyer guide 100 having only part of all the sides 118T, 118B, 118L, and 118R covered with the adhesive 120. Such selective application of the adhesive 120 may be more efficient as compared to applying the adhesive 120 fully on all the sides 118T, 118B, 118L, 118R, and may still allow for the automotive buyer guide 100 to be firmly adhered to a window of a vehicle. Once the liner 116 is removed to expose the adhesive area 118, the back side 115 of the automotive buyer guide 100 is adhered to a window of a vehicle from the outside, such that the front side 101 of the automotive buyer guide 100 is clearly visible when facing the window. Strategic placement of the adhesive 120 on the adhesive area 118 ensures that the automotive buyer guide 100 rolls up and down along the window without damaging the guide 100.

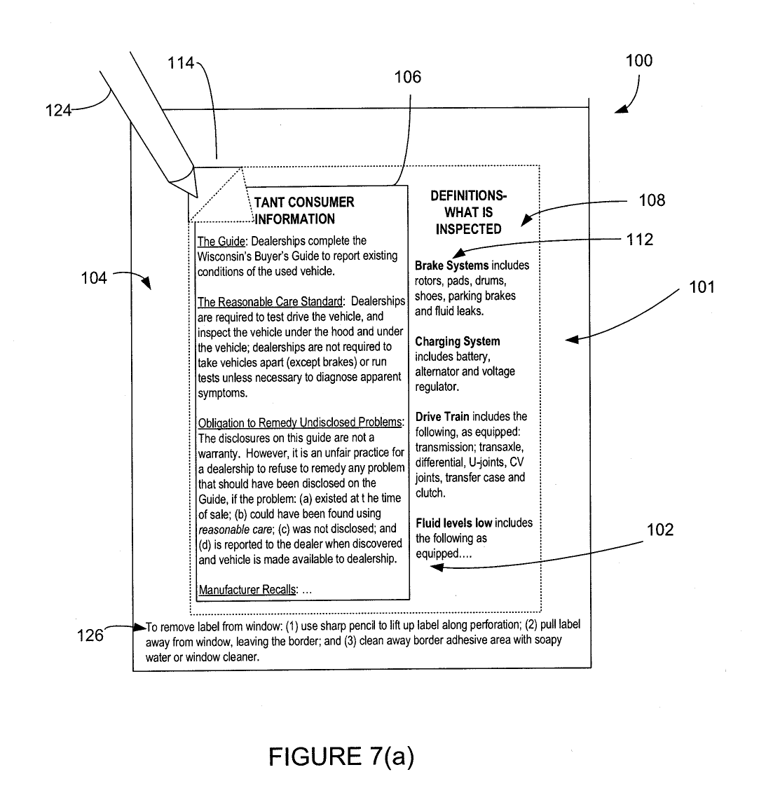

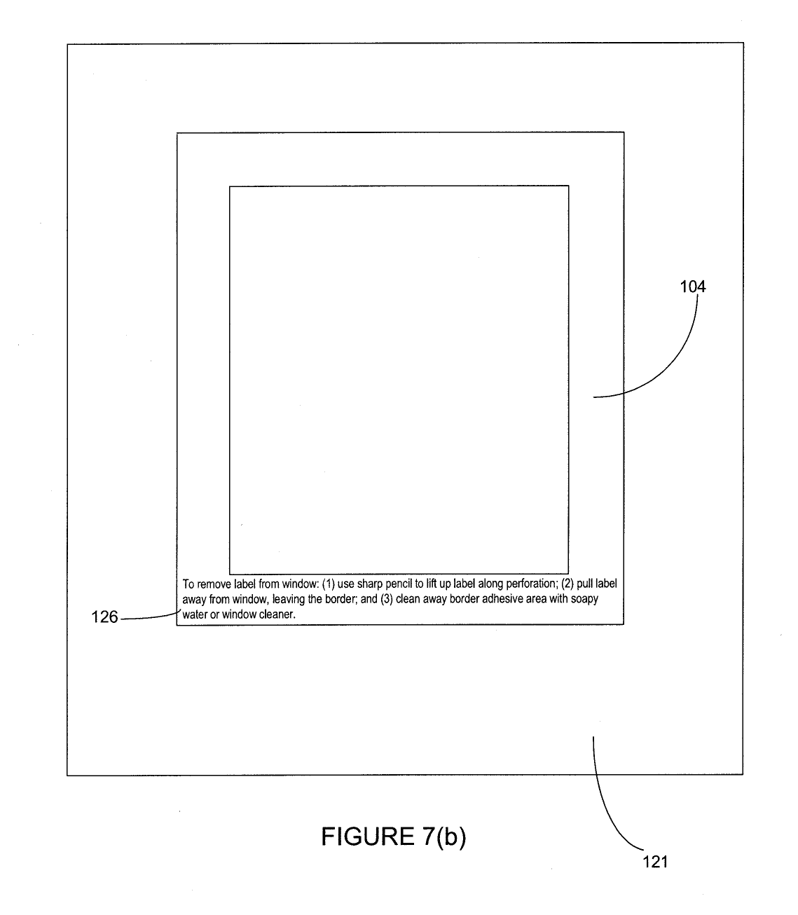

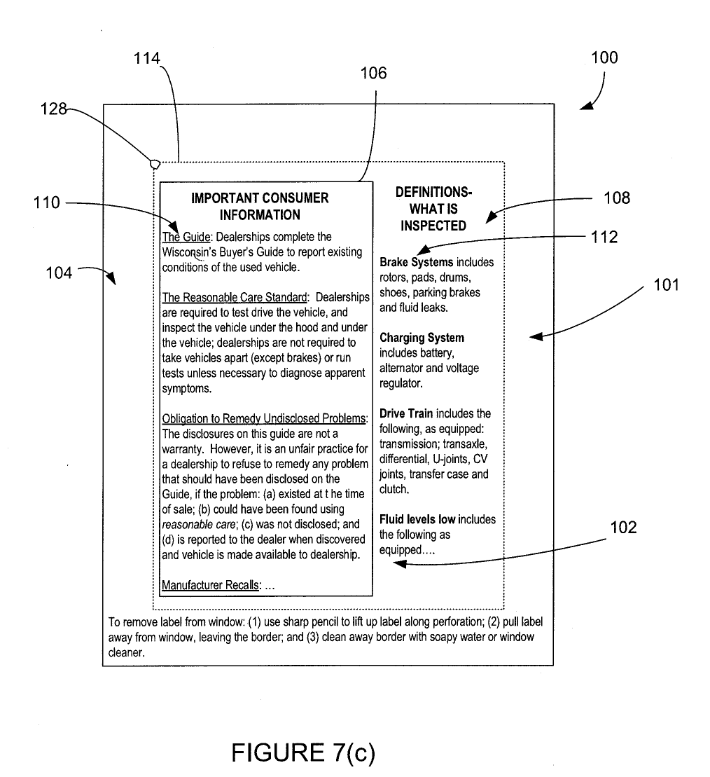

When a vehicle is sold, the dealer may be required to take the automotive buyer guide 100 off the vehicle's window before delivering the vehicle to the buyer. However, the buyer (or the dealer) may desire to retain the central portion 102, which may include important information 110 about the vehicle. For example, the buyer may wish to retain the central portion 102 in case he resells the vehicle, so as to convey the information 110 about the vehicle to the subsequent buyer. The automotive buyer guide 100 allows for convenient removal of the central portion 102 for retention. Specifically, the dealer (or the buyer) may use a sharp object to lift the central portion 102 off the automotive buyer guide 100 from the front side 101; for example, as shown in FIG. 7(a), the dealer may use a pencil 124 or some other sharp object to conveniently detach the central portion 102 along the perforated border 114 from the outer portion 104. The central portion 102 can thus be safely removed and retained, while the outer portion 104 remains adhered to the window (e.g., window 121 in FIG. 7(b)). The dealer may then simply wash off the outer portion 104 (which, as discussed, may be adhered using a water soluble adhesive 120) from the window 121 by using water, soap, a window cleaner, et cetera. The outer portion 104 may contain an instruction set 126 (FIG. 7(a)) that outlines the steps that can be performed to detach the central portion 102 and wipe away the outer portion 104. While not required, the back side 115 may include additional indicia outlining information about the vehicle. Various known technologies (e.g., standard barcodes, matrix (2D) bar codes, RFID scanners) and future technologies may be incorporated with the automotive buyer guide 100.

In some embodiments, a tab 128 may be secured to or formed integrally with the central portion 102 (see FIG. 7(c)). The central portion 102 may be conveniently detached along the perforated border 114 by pulling the tab 128. While the tab 128 may be located at a corner of the central portion 102 as in FIG. 7(c), people of skill in the art will appreciate that the tab 128 may also be located elsewhere (e.g., at an edge of the central portion 102).

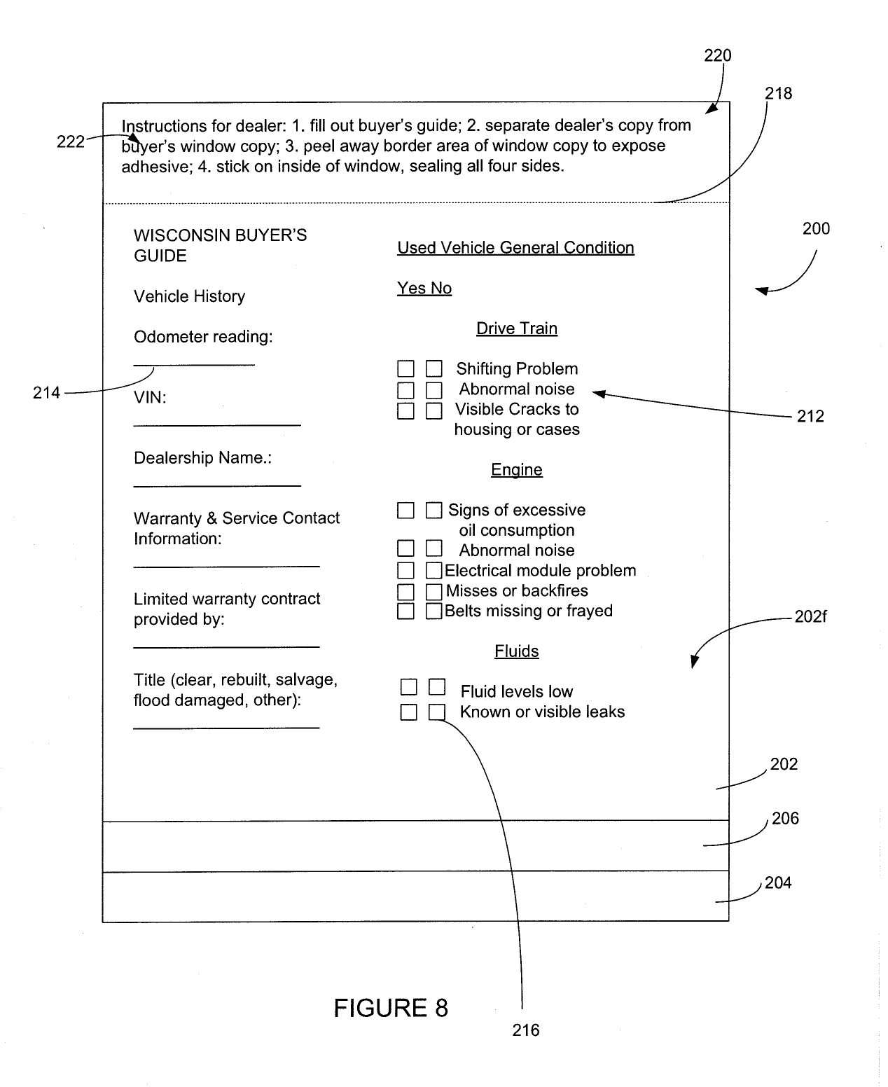

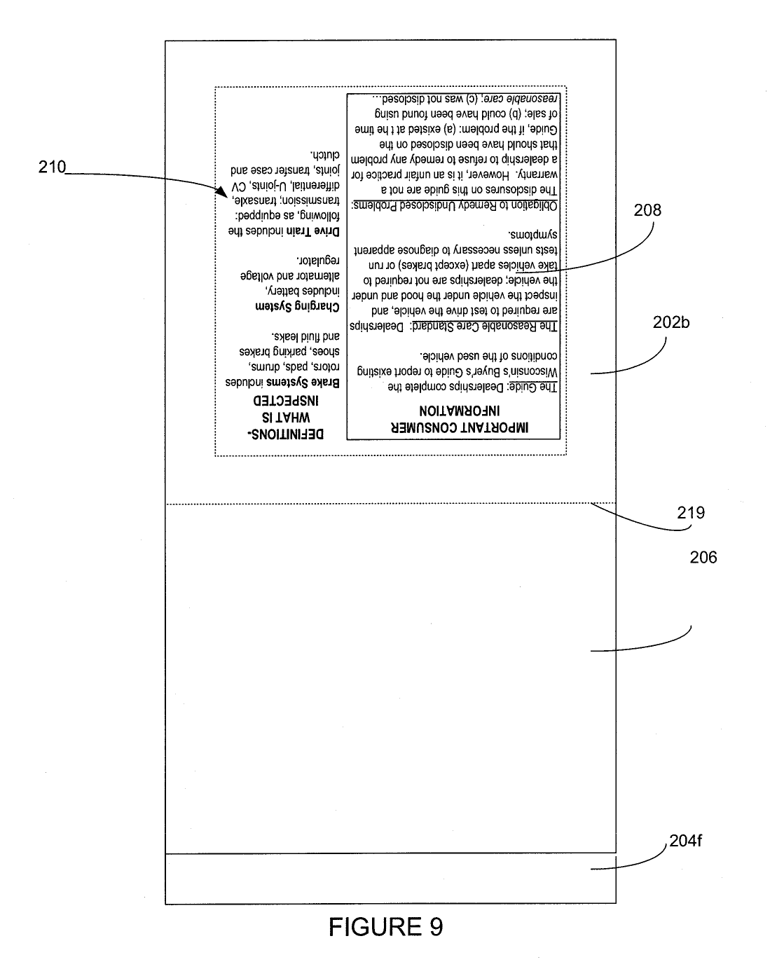

FIGS. 8 to 14 disclose an alternate embodiment 200 of the automotive buyer guide. The automotive buyer guide 200, like the automotive buyer guide 100, may be rectangular (e.g., 12×9.5 inches) or square shaped, or of other regular or irregular shapes and sizes. The automotive buyer guide 200 may include a dealer page 202, a buyer page 204, and a carbon copy sheet 206 disposed therebetween. The dealer page 202 may have a front side 202f (FIG. 8) and a back side 202b (FIG. 9). As can be seen in FIG. 9, the back side 202b of the dealer page 202 of the automotive buyer guide 200 may include information 208 and definitions 210 similar to the information 110 and the definitions 112 respectively on the front side 101 of the automotive buyer guide 100. The front side 202f of the dealer page 202 (FIG. 8), may include vehicle specific information 212, and may have blanks 214 and checkmark boxes 216 that are to be filled out by the dealer. For example, the vehicle specific information 212 may include blanks 214 for a particular vehicle's odometer reading and its vehicle identification number, and checkmark boxes 216 to convey the condition of that vehicle's drive train and engine.

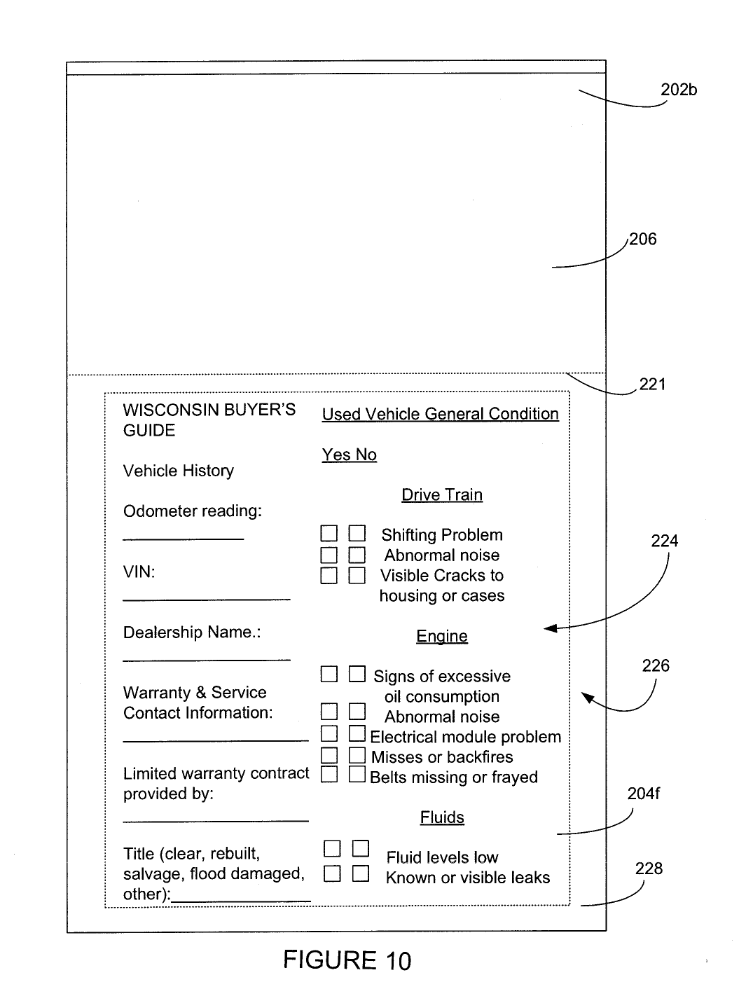

As can be seen in FIG. 10, a front side 204f of the buyer page 204 may include the same vehicle specific information 212 as the front side 202f of the dealer page 202. The dealer may fill out the blanks 214 and checkmark boxes 216 (i.e., the vehicle specific information 212) on the front side 202f of the dealer page 202 in accordance with the particular vehicle's condition. This vehicle specific information 212, by virtue of the carbon copy sheet 206, may be automatically copied on the front side 204f of the buyer page 204. The automotive buyer guide 200 may have a first perforated border 218 (FIG. 8) defining an instruction area 220, and each of the dealer page 202, the buyer page 204, and the carbon copy sheet 206 may be removably secured to the instruction area 220. Specifically, the dealer page 202 may be removably secured to the instruction area 220 at the first perforated border 218 (FIG. 8), the carbon copy sheet 206 may be removably secured to the instruction area 220 at a second perforated border 219 (FIG. 9), and the buyer page 204 may be removably secured to the instruction area 220 at a third perforated border 221 (FIG. 10). After filling out the vehicle specific information 212, the dealer may tear off the instruction area 220 along the first perforated border 218, the second perforated border 219, and the third perforated border 221 to separate the dealer page 202, the carbon copy sheet 206, and the buyer page 204, respectively. The instruction area 220 may include instructions 222 for the dealer to properly accomplish the steps disclosed herein. The dealer may retain the dealer page 202 for his records and recycle or dispose the carbon copy sheet 206.

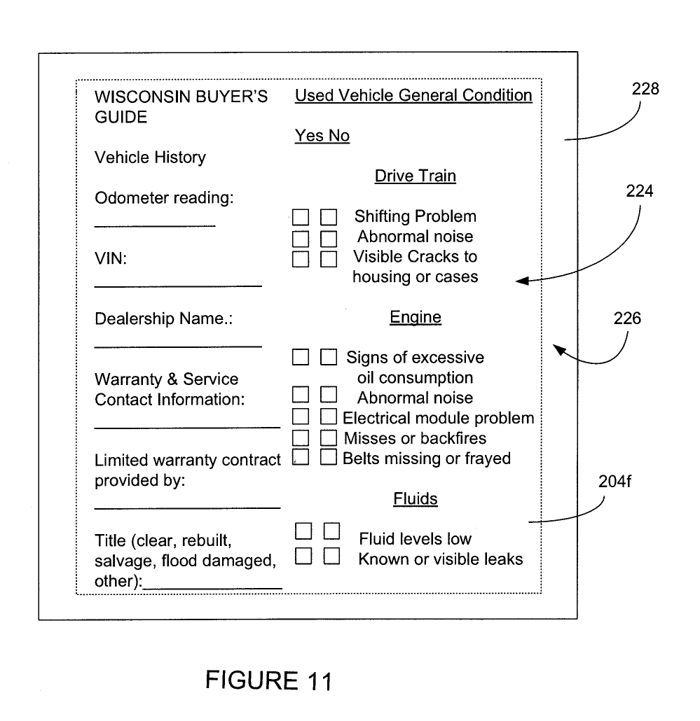

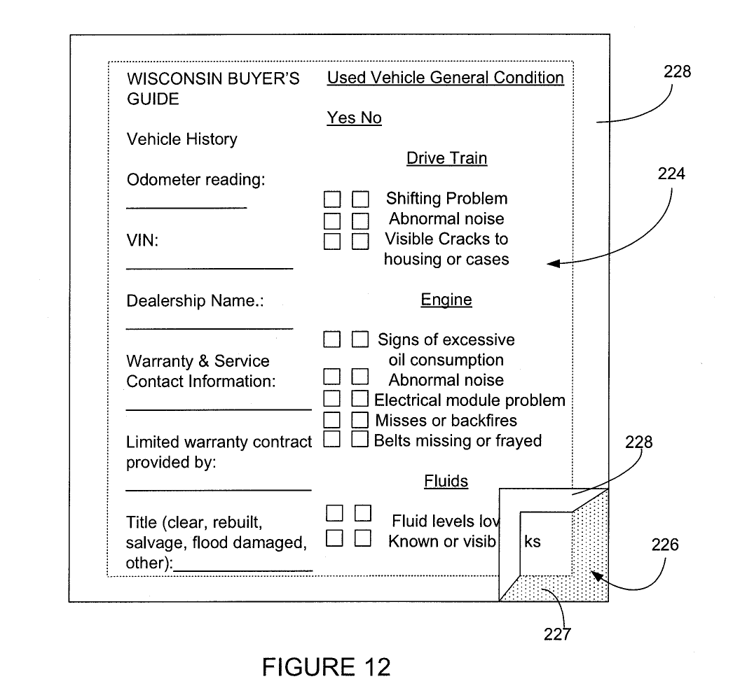

The front side 204f of the buyer page 204 may have a central portion 224 (where the vehicle specific information 212 is included), and an adhesive portion 226 that surrounds the central portion 224 (FIG. 10). The adhesive portion 226 may include an adhesive 227 (e.g., a water soluble adhesive applied in a continuous pattern via a flexographic printing plate), and a liner 228 may initially cover the adhesive portion 226. As disclosed with respect to the automotive buyer guide 100, the adhesive 227 need not be applied to the entire adhesive portion 226, and may be selectively applied. After the dealer page 202 and the carbon copy sheet 206 have been detached (FIG. 11), the dealer may remove the liner 228 (FIG. 12) exposing the adhesive portion 226. The dealer may then stick the buyer page 204 (i.e., the adhesive portion 226) to an inside of a vehicle's window (e.g., window 121 in FIG. 7(b)), such that the front side 204f of the buyer page 204 is visible when facing the window from the outside. The window may be rolled up and down without damaging the buyer page 204.

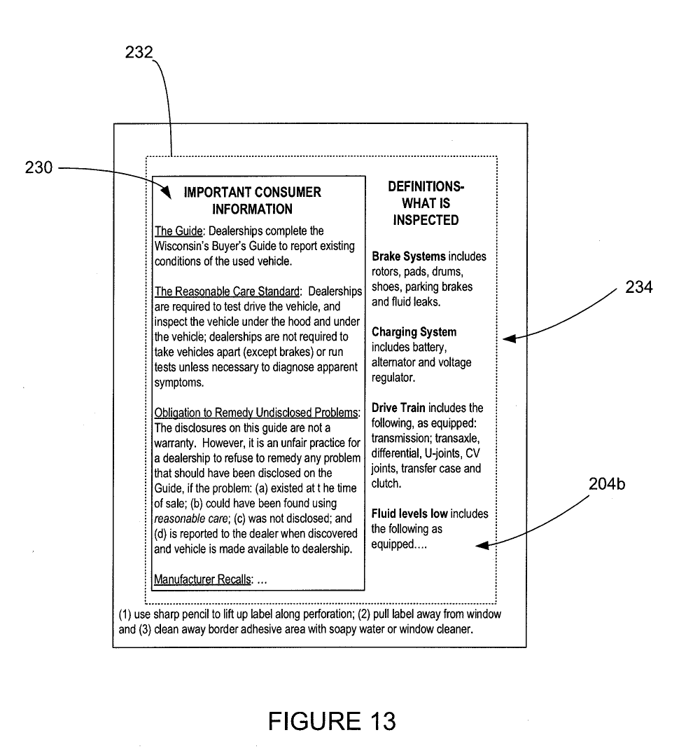

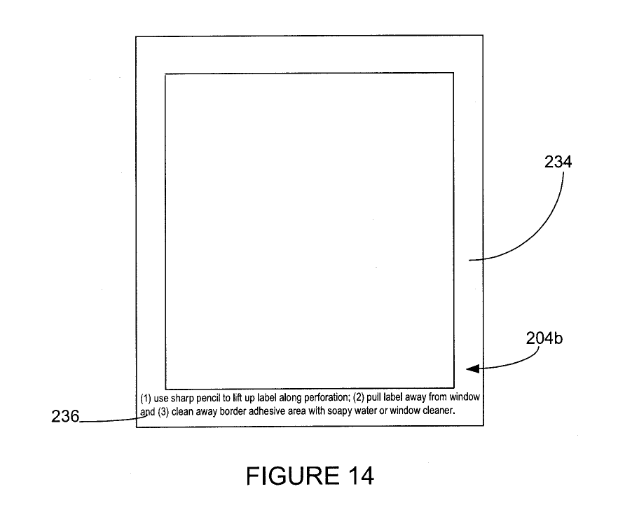

The back side 204b (FIG. 13) of the buyer page 204 (which can be viewed when sitting inside the car or from the opposite window) may include the same information 208 and the definitions 210 as the back side 202b of the dealer page 202. This information 208 and definitions 210 on the back side 204b of the buyer page may be provided in a central area 230 surrounded by a fourth perforated border 232 (FIG. 13). An outer area 234 may surround the fourth perforated border 232. When the dealer (or the buyer) wants to remove the buyer page 204 from the window, he may simply detach the central area 230 from the outer area 234 by using a sharp object (e.g., a pencil), leaving the outer area 234 on the window (FIG. 14, showing the outer area 234 left on a vehicle's window after the central area 230 has been removed). The outer area 234 may then be washed off using water, soap, a window cleaner, et cetera, whereas the central area 230 may be retained by the buyer. Additional instructions 236 may be provided on the outer area 234 (along with instructions 222 on the front side 202f of the dealer page 202, as shown in FIG. 8) to enable a user to accomplish the steps disclosed herein.

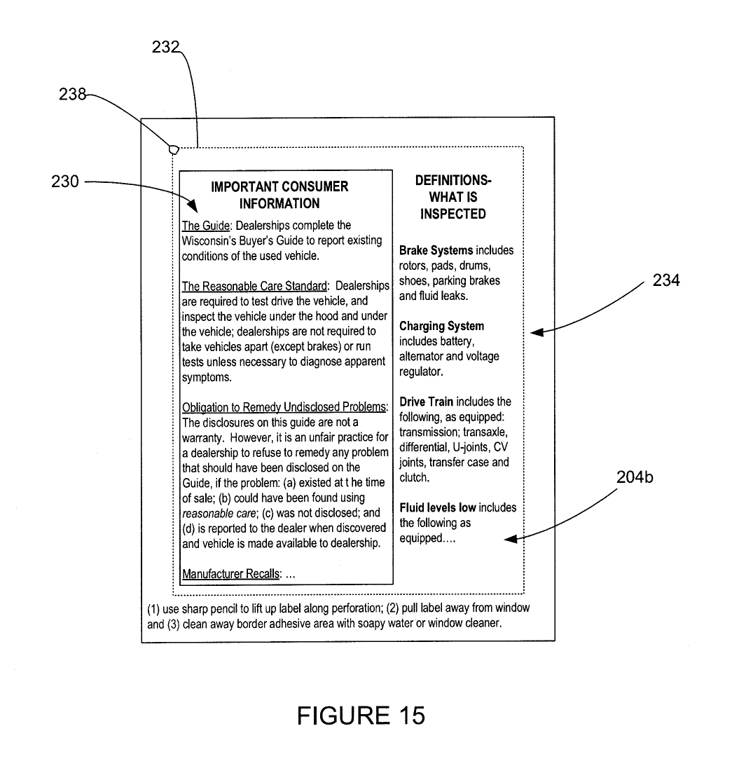

While not required, in some embodiments, a tab 238 may be secured to or formed integrally with the central area 230 (see FIG. 15). The central area 230 may be conveniently detached along the fourth perforated border 232 by pulling the tab 238. While the tab 238 may be located at a corner of the central area 230 as shown in FIG. 15, people of skill in the art will appreciate that the tab 238 may also be located elsewhere (e.g., at an edge of the central area 230).

Many different arrangements of the various components depicted, as well as components not shown, are possible without departing from the spirit and scope of the present invention. Embodiments of the present invention have been described with the intent to be illustrative rather than restrictive. Alternative embodiments will become apparent to those skilled in the art that do not depart from its scope. A skilled artisan may develop alternative means of implementing the aforementioned improvements without departing from the scope of the present invention. It will be understood that certain features and subcombinations are of utility and may be employed without reference to other features and subcombinations and are contemplated within the scope of the claims.

The invention claimed is:

1. An automotive buyer guide, comprising:
a dealer page having a first front side and a first back side;
a buyer page having a second front side and a second back side; the second front side having a central portion and an adhesive portion surrounding the central portion; at least part of the adhesive portion comprising an adhesive; the central portion and the adhesive portion being separated by a perforated boundary;
a liner generally corresponding to the adhesive portion; the liner being removably affixed to the adhesive portion;
a carbon copy sheet disposed between the dealer page and the buyer page; the carbon copy sheet being adjacent the first back side and the second front side; and
an instruction area;
wherein:
the dealer page is removably secured to the instruction area at a first perforated border;
the carbon copy sheet is removably secured to the instruction area at a second perforated border;
the buyer page is removably secured to the instruction area at a third perforated border;
the adhesive portion is configured to allow for securement of the buyer page to an inside of a window of a vehicle after the buyer page is detached from the instruction area;
the central portion can be detached from the adhesive portion along the perforated boundary after the buyer page is secured to the window.

2. The automotive buyer guide of claim 1, wherein:
the first front side includes at least a first checkmark box;
the second front side includes at least a second checkmark box; and
the carbon copy sheet is configured to copy indicia placed on the first checkmark box onto the second checkmark box.

3. The automotive buyer guide of claim 2, wherein the adhesive is a water soluble adhesive.

4. The automotive buyer guide of claim 3, wherein the adhesive area comprises a top side, a bottom side, a left side, and a right side; and
at least a middle part of each of the top side, the bottom side, the left side, and the right side is devoid of the adhesive.

5. The automotive buyer guide of claim 4, wherein the adhesive is placed on the adhesive area in a dot pattern.

6. The automotive buyer guide of claim 5, wherein the window can be rolled down without damaging the guide.

7. The automotive buyer guide of claim 6, wherein a tab is secured to the central portion at the second back side; and
the central portion can be detached from the adhesive portion by pulling the tab.

8. A method for a seller to convey information about a vehicle for sale to a buyer, the method comprising steps:
(a) providing an automotive buyer guide, comprising:
i. a seller page having a first front side and a first back side;
ii. a buyer page having a second front side and a second back side; the second front side having a central portion and an adhesive portion surrounding the central portion; at least part of the adhesive portion comprising an adhesive; the central portion and the adhesive portion being separated by a perforated boundary;
iii. a liner generally corresponding to the adhesive portion; the liner being removably affixed to the adhesive portion;
iv. a carbon copy sheet disposed between the seller page and the buyer page; the carbon copy sheet being adjacent the first back side and the second front side; the carbon copy sheet configured to duplicate indicia placed on the first front side onto the second front side;
v. an instruction area;
wherein:
the seller page is removably secured to the instruction area at a first perforated border;
the carbon copy sheet is removably secured to the instruction area at a second perforated border;
the buyer page is removably secured to the instruction area at a third perforated border;
the adhesive portion is configured to allow for securement of the buyer page to a window of a vehicle after the buyer page is detached from the instruction area;
the central portion can be detached from the adhesive portion along the perforated boundary after the buyer page is secured to the window;
(b) placing indicia on the first front side;
(c) detaching the buyer page from the instruction area;
(d) removing the liner from the adhesive portion; and
(e) securing the buyer page to an inside of the window such that the adhesive portion is in contact with the window.

9. The method of claim 8, wherein the adhesive is a water soluble adhesive.

10. The method of claim 9, wherein:
the adhesive portion comprises a top side, a bottom side, a left side, and a right side; and
at least part of each of the top side, the bottom side, the left side, and the right side is devoid of the adhesive.

11. The method of claim 10, wherein the adhesive is applied to the adhesive portion in a dot pattern.

12. The method of claim 11, wherein:
a tab is secured to the central portion at the second back side; and
the central portion can be detached from the adhesive portion by pulling the tab.

13. An automotive buyer guide, comprising:
a front side having a central portion and an outer portion; the central portion and the outer portion being separated by a perforated border;
a back side having an adhesive area; the adhesive area generally corresponding to the outer portion; at least part of the adhesive area comprising an adhesive; and
a liner generally corresponding to the adhesive area; the liner being removably affixed to the adhesive area;
wherein the adhesive area is configured to allow for securement of the back side to a window of a vehicle;
wherein the central portion can be detached from the outer portion along the perforated border after the automotive buyer guide is secured to the window.

14. The automotive buyer guide of claim 13, wherein the adhesive is a water soluble adhesive.

15. The automotive buyer guide of claim 14, wherein the adhesive comprises acrylic.

16. The automotive buyer guide of claim 15, wherein the adhesive is placed on the adhesive area in a dot pattern.

17. The automotive buyer guide of claim 16, wherein:
the adhesive area comprises a top side, a bottom side, a left side, and a right side; and
at least a portion of each of the top side, the bottom side, the left side, and the right side is devoid of the adhesive.

18. The automotive buyer guide of claim 17, wherein the window can be rolled down without damaging the guide.

19. The automotive buyer guide of claim 18, wherein:
the central portion comprises a definitions column and a text box; and
each of the definitions column, the text box, and the outer portion includes indicia.

20. The automotive buyer guide of claim 18, wherein:
the central portion includes a tab; and
the central portion can be detached from the central portion along the perforated border by pulling the tab.
